(19) United States
(12) Patent Application Publication
(10) Pub. No.: US 2010/0072784 A1
(43) Pub. Date: Mar. 25, 2010

(54) TRANSVERSE-MEMBER MODULE FOR A MOTOR VEHICLE

(75) Inventors: Thomas MALEK, Pulheim (DE); Frank Lutter, Dusseldorf (DE); Boris Koch, Wermelskirchen (DE); Ulrich Dajek, Leverkusen (DE)

Correspondence Address: Hildebrand, Christa;Norris McLaughlin & Marcus PA, 875 Third Avenue, 8th Floor, New York, NY, 10022, US

(73) Assignee: LANXESS Deutschland GmbH, Leverkusen (DE)

(21) Appl. No.: 12/547,928

(22) Filed: Aug. 26, 2009

(30) Foreign Application Priority Data
Aug. 26, 2008 (DE) 10 2008 039 652.4

(51) Int. Cl. B62D 25/00; B62D 25/14

(52) U.S. Cl. 296/193.01

(57) ABSTRACT

The present invention relates to a transverse-member module for receiving the instrument panel and reinforcing the bodywork via direct connection of the two A-pillars of a motor vehicle, composed of a transverse member with a steering-column retainer, where the transverse-member module, i.e. not only the transverse member but also the steering-column retainer, are produced using a metalplastic-composite design (hybrid technology).

### BACKGROUND OF THE INVENTION

This application claims priority under 35 USC §119 to German Patent Application filed on Aug. 26, 2008 as DE 10 2008 039 652.4, the entire contents is hereby incorporated by reference.

The present invention relates to a transverse-member module for receiving the instrument panel and reinforcing the bodywork via direct connection of the two A-pillars of a motor vehicle, composed of a transverse member with a steering-column retainer, where the transverse-member module, i.e. not only the transverse member but also the steering-column retainer, are produced using a metal-plastic-composite design (hybrid technology).

### DESCRIPTION OF THE RELATED ART

Known steering-column retainers, also termed steering consoles, are composed of a plurality of welded sheet-metal profiles in steel or diecast components (e.g. composed of aluminium or magnesium), forming a single piece with the load-bearing structure of the instrument-panel transverse member to give transverse-member modules, or securely connected in welded form or in the form of combined profiles, composed of aluminium, of steel, of magnesium, or of plasticsmetal-hybrid design.

DE 10 2005 004 605 A1 discloses a transverse-member module for a motor vehicle comprising an at least partially plastics-surrounded metal tube, with, moulded on so as to form a single piece, a plastics duct through which a conductor set can be passed, with a moulded-on link composed of plastic, for fixing to the front wall of the motor vehicle by screw-thread methods.

DE 102 40 395 A1 discloses a transverse member which is intended for a motor vehicle and which, in the region of the curved portion of the tube, has a welded-on metal steering-column link, onto which the screw-on plate of the steering column is mounted. The manufacture of the curved section of the said transverse member uses a metal-plastics-hybrid design.

DE 200 08 201 U1 discloses an instrument-panel support in hybrid-type configuration for installation between the A-pillars of a motor vehicle and having an elongate, shell-like main body, and also stabilizing insert parts composed of metallic materials, which have been joined via moulded-on interior plastics ribbing to give a metal/plastics-composite part, and through which at least one air duct passes at least to some extent, where, simultaneously with the plastics ribbing, retainers, consoles and linkage points composed of plastic and projecting outwards from the main body have been moulded on so as to give a single piece.

DE 100 64 522 A1 describes a component for a motor vehicle, in particular transverse member for arrangement between A-pillars of a motor vehicle, with an essentially tube-like main body, within which there is at least one duct provided. In order to provide an improved lightweight component which can be produced more easily, with fewer operations, and therefore at lower cost, and into which a duct can be integrated in advantageous manner, DE 100 64 522 A1 proposes that the main body have an internal lining of plastic to foult duct walls composed of plastic. The said component can be used as instrument-panel support in a motor vehicle. Holders, such as a steering-column holder, are attached to the main body, and these holders are likewise preferably composed of metal. According to DE 100 64 522 A1, the holders can be surrounded by plastic, thus increasing their stiffness, eliminating rattle, and providing edge protection.

A feature common to all of the solutions described in the prior art for the connection of steering-column retainer and transverse member is that they either comprise only holders composed of metal or composed of plastic which do not receive a steering console until an additional operation is carried out, or, to the extent that the moulding-on of the steering console is simultaneous with that of the plastic for the ribbing, this is composed solely of plastic, as is the case in DE 200 08 201 U1.

The consequence of the two-part design is increased operating cost, and the consequence of the solution entirely composed of plastics according to DE 200 08 201 U1 is lack of stability. The solutions described in the prior art moreover exhibit disadvantageous vibration behaviour, perceptibly extending as far as the steering wheel. Although DE 10 2005 004 605 A1 indicates that the proposed hybrid design of the transverse-member module reduces oscillating mass, but provides a transverse member with relatively high intrinsic frequency, giving a transverse-member module with a high level of vibration comfort, it has been found that in modified vehicle configurations this vibration behaviour solely of the transverse member is insufficient, and that unpleasant vibration behaviour extends as far as the steering wheel.

The object of the present invention therefore consisted in improving the intrinsic vibration behaviour of the entire instrument-panel support together with the steering console and the steering column to be secured thereto (also termed steering-column tube) with the aim that firstly the first-mode natural frequency measured at the steering wheel is >36 Hz, and, in comparison with the prior art cited above, additional results are a further weight reduction, cost reduction, and also simplified production processes.

The difficulty consists specifically in the fact that the steering-column retainer has the task of 30 receiving the steering column and serving as important connection element between the bulkhead (constituent of load-bearing bodywork) and the instrument-panel transverse member. The steering-column retainer here must produce a connection of maximum stiffness which has a decisive effect on the intrinsic vibration behaviour of the instrument-panel transverse member. The undesirable intrinsic vibrations are caused by, for example, excitation derived from the engine, from the power train and from the chassis. These vibrations propagate by way of the bodywork into the steering rod and into the steering wheel, and also into the entire dashboard, causing vibrations at the steering wheel and noise in the interior of the vehicle. The result is unacceptable reductions in comfort.

The object is achieved, and the present invention therefore provides, a transverse-member module for receiving the instrument panel of a motor vehicle comprising an at least partially plastics-surrounded metal tube and a simply moulded sheet-metal profile functioning as steering-column retainer and designed and placed in such a way that it, in the composite with moulded-on plastic, firstly gives a stiff connection between steering column and front wall and secondly has firm connection to the metal tube by way of a structure consisting entirely of plastic.

Surprisingly, the secure connection of transverse-member module and a steering-column retainer likewise manufactured using hybrid design gives, in the installed condition, optimized intrinsic vibration behaviour, i.e. a first-mode natural frequency >36 Hz at the steering wheel, and also a reduction in the cost and the weight of the entire vehicle. Finally, this combination of transverse-member module and steering-column retainer can be produced in simplified manner in a single operation, by overmoulding and connecting two metal parts (metal tube and the moulded metal sheet) together in the same mould in a single operation.

The present invention also provides a process for influencing the intrinsic vibration behaviour of the instrument-panel support of motor vehicles in the installed condition to give a first-mode natural frequency >36 Hz, characterized in that a transverse-member module is attached under the instrument panel, comprising an at least partially plastics-surrounded metal tube and a simply moulded sheet-metal profile functioning as steering-column retainer and designed and placed in such a way that it, in the composite with moulded-on plastic, firstly gives a very stiff connection between steering column and front wall and secondly has firm connection to the metal tube by way of a structure consisting entirely of plastic.

The present invention also provides the use of a transverse-member module for attachment under the instrument panel of a motor vehicle, comprising an at least partially plastics-surrounded metal tube and a simply moulded sheet-metal profile functioning as steering-column retainer and designed and placed in such a way that it, in the composite with moulded-on plastic, firstly gives a stiff connection between steering column and front wall and secondly has firm connection to the metal tube by way of a structure consisting entirely of plastic, for influencing the intrinsic vibration behaviour of the instrument-panel support in the installed condition to give a first-mode natural frequency >36 Hz. In one preferred embodiment, the first-mode natural frequency is from 36.1 to 50 Hz, particularly preferably from 37.1 to 39 Hz.

In one preferred embodiment, the plastics structure produced in the injection-moulding procedure for the transverse-member module includes reinforcing ribs which not only stiffen the connection to the instrument-panel transverse member but also assume the function of bracing and supporting the overmoulded sheet-metal profile, and bring about transmission of force into the front wall over a large area. The reinforcing ribs in turn have preferably been securely connected to the sheet-metal profile at discrete connection sites by way of perforations in the sheet-metal profile, where the plastic extends through the perforations and extends over the surface of the perforations.

In one preferred embodiment of the present invention, the metal tube and/or the sheet-metal profile used for the steering-column retainer has a coating of adhesion promoter or adhesive. DE 10 2006 025 745 A1 discloses adhesion promoters to be used according to the invention, and its entire content relating to this matter is incorporated by way of reference into the present application. The adhesion promoter or adhesive is preferably a two-stage adhesion promoter which crosslinks completely in two sequential steps, preferably via thermal activation. The adhesion promoter or adhesive can be applied to the sheet-metal profile or metal material prior to stamping and/or shaping, etc. This type of application preferably takes place onto the sheet-metal profile by the “coil-coating” process, prior to operations thereon. This process is particularly cost-efficient. However, the adhesion promoter or adhesive can also be applied by spray, dip-coat, or powder-spray methods, etc. After application to the sheet-metal profile and/or metal tube, it is partially crosslinked in a first step, thus faulting a surface which is “dry to the touch”, with adequate resistance to damage from handling. During or after the moulding-on of the plastic, the adhesion promoter or adhesive is crosslinked completely, so that it obtains its final properties. In order to achieve the activation energy necessary for the second phase of crosslinking of the adhesion promoter, it can be advantageous to heat the plastics mould and/or to heat the sheet-metal insert profile or the metal tube, and/or to ensure that the temperature of injection of the plastics material into the injection mould is sufficiently high to bring about crosslinking. As an alternative, it is possible to achieve complete crosslinking by annealing after the moulding-on process.

The adhesion promoter or adhesive which provides the coherent link between plastic and sheet-metal profile and/or metal tube is preferably a polyurethane system or an epoxy system, particularly preferably an epoxy resin based on bisphenol A and/or on bisphenol B and/or on bisphenol C and/or on bisphenol F.

Preferred adhesion-promoter systems or adhesives for the plastics materials to be used according to the invention are based on elastomer-modified epoxy adhesives, particularly with covalent linking via copolymerization of 1,3-butadienes and/or with physical binding via addition of rubber.

In an alternative, preferred embodiment, the sheet-metal profile is connected to the plastics structure of the metal tube in a separate process step, only after the overmoulding process, via hot-riveting or other types of riveting, clinching, adhesive bonding, or screw-thread methods.

In one preferred embodiment of the invention, the metal tube used in the transverse-member module is a pipe pinched at both ends, with holes located in both pinched ends. The holes provided at the pinched ends serve as screw-on lugs for the A-pillars during the assembly of the transverse-member module within the vehicle bodywork. The advantage of this design is that there is no need for welding-on of additional angle brackets, such as those otherwise conventional for linking A-pillars in the prior art. The additional manufacturing step for welding-on of an A-pillar link can therefore be omitted, and problems of distortion at these sites are therefore also eliminated.

It is moreover preferable that the transverse-member module has, in addition to the steering-column retainer, a moulded-on plastics lug at each pinched end of the metal pipe, and that there is a through-bore located in each moulded-on plastics lug. This further through-bore serves for further linking of the transverse-member module to the A-pillar, and particularly for excluding any rotation of the transverse-member module about the longitudinal axis of the metal tube.

According to one preferred embodiment of the invention, the metal tube is composed of steel and is preferably seamless. The material of the metal tube can generally be selected with a view to the mechanical properties demanded. As a function of vehicle type, moreover, relatively high importance has to be allocated either to installation-space optimization or to weight optimization, and this likewise influences the selection of a suitable material for the metal tube. Finally, because there is direct contact between the metal pipe and the A-pillar in the motor vehicle, the selection of material also takes into account corrosion requirements relevant to this pairing of materials. The metal tube is preferably seamless, but can also be a metal tube with a longitudinal weld seam or else an extruded metal tube. The exterior dimensions of the metal tube preferably have narrow tolerances, in order that the injection mould forms a tight seal with the steel tube and high manufacturing quality can be achieved during the partial overmoulding of the metal tube and of the steering-column retainer with plastic. In one preferred embodiment, the metal tube is of straight design, i.e. it has no curved portions where curvature deformation can occur if pressure forces are introduced into the metal tube by way of the pinched ends (in the event of a side impact).

The transverse-member module preferably has moulded-on receiving means for a passenger airbag and/or moulded-on receiving means for knee protectors and/or moulded-on receiving means for a radio unit and/or navigation unit. All of the receiving means mentioned, which can have been moulded on as alternatives or in any desired combination with one another, as a single piece on the transverse-member module, facilitate the assembly of various cockpit components. A further receiving means moulded-on as alternative or in combination serves for linking of the cardan tunnel. An advantage of cardan tunnel linking is that the transverse-member module has, between the securing points to the respective A-pillars, an additional securing point to the vehicle bodywork, thus firstly increasing the strength and stiffness of the entire composite and secondly also advantageously influencing the vibration behaviour of the transverse-member module.

According to one preferred embodiment of the invention, the transverse-member module also comprises, on the metal tube, regions not surrounded by the plastic, these serving for the attachment of connection elements, by way of which it is possible to secure a screw-on plate of the steering column. Connection elements can be used to integrate the steering-column link. Preferred connection elements are pipe clamps. This method also eliminates any welded connection, with its attendant problems of distortion, in the region of the steering-column link. To permit secure attachment, this method is preferably used directly at the metal tube, i.e. at a site not surrounded by plastic.

According to one preferred embodiment of the invention, the transverse-member module also comprises foam elements which surround the conductor set passed through the plastics duct, and which can be inserted into a plastics duct optionally provided on the metal tube, and which are of dimensions such that they expand elastically in the plastics duct and become fixed against its inner wall. The foam elements are preferably composed of PE foam, foam rubber or similar materials. PE foam is very inexpensive, whereas foam rubber is advantageous in relation to elasticity and the coefficient of friction important for fixing within the plastics duct (PE=polyethylene). The advantage of the foam elements is that various thicknesses of conductor sets can be accepted by virtue of the elasticity of the foam elements. Conductor sets of differing thickness occur particularly with the use of customer-specific cable harnesses. The compressibility of the foam elements and their recovery properties can be used to fix the conductor set within the optionally present plastics cable duct. It is moreover possible to eliminate the complicated use of adhesive tape for winding around the entire bundle of individual conductors, because the foam elements eliminate rattle of the individual conductors in the optionally present plastics duct.

In the plastics duct there are moreover preferably moulded-on guide grooves arranged parallel to one another, between each of which a foam element can be inserted. This method can not only facilitate precise positioning during insertion of the foam elements but can also ensure exact positioning of the individual foam elements within the plastics duct.

According to one preferred embodiment, the conductor set passed through the optionally present plastics duct comprises individual conductors held together in essence only by binders. Binders are used in order to define the position of branching conductors. In other words, winding around the entire bundle of individual conductors can be eliminated, and the only remaining requirement is for binders at those sites where there is defined branching of individual conductors or of strands thereof.

The dimensioning of the plastics duct is preferably such that it can receive a conductor set for the entire on-board network. The conductor set here also comprises an engine-compartment conductor set, preferably surrounded by a plate or bushing, the dimensions of which have been matched to the size of an aperture in the front wall of the vehicle. It is therefore possible, with the assembly process for the transverse-member module, to assemble, within the plastics duct, a conductor set which by this stage comprises the engine-compartment conductor set, and which is passed into the engine compartment through an appropriate aperture in the front wall. To permit leakproof reclosure of the appropriate aperture in the front wall, the appropriate plate or bushing has been provided by this stage, for this purpose.

The materials used for the sheet-metal profile of the steering-column retainer, or those used for the metal tube, are preferably steel, aluminium, aluminium alloys, steel alloys, magnesium, titanium, or glass- or carbon-fibre-reinforced plastics. In an alternative embodiment of the present invention, the sheet-metal profiles composed of various materials from the abovementioned series can be combined with one another. Steel is particularly preferably used for the metal tube.

In order to obtain the rib structure of the material surrounding the tube, and to obtain the connection of transverse-member module and steering-column retainer, thermoplastic polymers are preferably used in the form of polymer moulding compositions.

The processing of the polymer moulding compositions for the abovementioned purposes, using a plastics-metal-composite design, takes place via shaping processes for thermoplastics, preferably via injection moulding, melt extrusion, compression moulding, stamping or blow moulding. In principle, the advantageous effects to be achieved are apparent with thermoplastics of any type. A list of the thermoplastics to be used as component A) is found by way of example in Kunststoff Taschenbuch [Plastics Handbook] (Ed. Saechtling), 1989 edition, which also mentions sources. Processes for the production of these thermoplastics are known per se to the person skilled in the art. The effects to be achieved are likewise apparent in all of the variations disclosed in the prior art cited above of the use of hybrid technology, irrespective of whether the plastics part encapsulates the metal part completely or, as in the case of EP 1 380 493 A2, merely forms a web around it, and irrespective of whether the plastics part is subsequently incorporated by adhesion or connected by way of example by a laser to the metal part, or whether, as in WO 2004/071741, the plastics part and the metal part obtain the secure interlock bond in an additional operation.

Preferred semicrystalline thermoplastic polymers (thermoplastics) for the transverse-member module of the invention, composed of metal tube and steering-column retainer, using hybrid design, are those selected from the group of the polyamides, vinylaromatic polymers, ASA polymers, ABS polymers, SAN polymers, POM, PPE, polyarylene ether sulphones, polypropylene (PP) or their blends, preference being given here to polyamide, polyester, polypropylene and polycarbonates or blends comprising polyamide, polyester or polycarbonates as essential constituent.

It is particularly preferable that the material used in the moulding compositions to be processed comprises at least one polymer from the series of polyester, polycarbonate, polypropylene or polyamide or blends of these thermoplastics with the abovementioned materials.

Polyamides to be used with particular preference according to the invention are semicrystalline polyamides (PA), which can be prepared starting from diamines and dicarboxylic acids and/or from lactams having at least 5 ring members, or from corresponding amino acids. Starting materials that can be used for this purpose are aliphatic and/or aromatic dicarboxylic acids, such as adipic acid, 2,2,4- and 2,4,4-trimethyladipic acid, azelaic acid, sebacic acid, isophthalic acid, terephthalic acid, and aliphatic and/or aromatic diamines, e.g. tetramethylenediamine, hexamethylenediamine, 1,9-nonanediamine, 2,2,4- and 2,4,4-trimethylhexamethylenediamine, the isomeric diaminodicyclohexylmethanes, diamimodicyclohexylpropanes, bisaminomethylcyclohexane, phenylenediamines, xylylenediamines, aminocarboxylic acids, e.g. aminocaproic acid, and the corresponding lactams. Copolyamides composed of a plurality of the monomers mentioned are included.

Polyamides preferred according to the invention are prepared from caprolactams, very particularly preferably from E-caprolactam, and also most of the compounding materials based on PA6, on PA66, and on other aliphatic and/or aromatic polyamides or copolyamides, where there are from 3 to 110 methylene groups for every polyamide group in the polymer chain.

Semicrystalline polyamides to be used according to the invention can also be used in a mixture with other polyamides and/or with further polymers.

Conventional additives, e.g. mould-release agents, stabilizers and/or flow aids, can be admixed in the melt with the polyamides or applied to the surface.

Polyesters are likewise preferred for use according to the invention, these being polyesters based on aromatic dicarboxylic acids and on an aliphatic or aromatic dihydroxy compound.

A first group of preferred polyesters is that of polyalkylene terephthalates, in particular those having from 2 to 10 carbon atoms in the alcohol moiety.

Polyalkylene terephthalates of this type are known and are described in the literature. Their main chain comprises an aromatic ring which derives from the aromatic dicarboxylic acid. There may also be substitution in the aromatic ring, e.g. by halogen, especially chlorine or bromine, or by C1C₄-alkyl groups, especially methyl, ethyl, iso- or n-propyl, or n-, iso- or tert-butyl groups.

These polyalkylene terephthalates may be prepared by reacting aromatic dicarboxylic acids, or their esters or other ester-forming derivatives, with aliphatic dihydroxy compounds in a known manner.

Preferred dicarboxylic acids that may be mentioned are 2,6-naphthalenedicarboxylic acid, terephthalic acid and isophthalic acid, and mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Among the aliphatic dihydroxy compounds, preference is given to diols having from 2 to 6 carbon atoms, in particular 1,2-ethanediol, 1,3-propanediol, 1,4-butanediol, 1,6-hexanediol, 1,4-hexane-diol, 1,4-cyclohexanediol, 1,4-cyclohexanedimethanol and neopentyl glycol, and mixtures of these.

Polyesters whose use is very particularly preferred are polyalkylene terephthalates derived from alkanediols having from 2 to 6 carbon atoms. Among these, particular preference is given to polyethylene terephthalate (PET), polypropylene terephthalate and polybutylene terephthalate (PBT), and mixtures of these. Preference is also given to PET and/or PBT which comprise, as other monomer units, up to 1% by weight, preferably up to 0.75% by weight, of 1,6-hexanediol and/or 2-methyl-1,5-pentanediol.

The viscosity number of polyesters whose use is preferred according to the invention is generally in the range from 50 to 220, preferably from 8 to 160 (measured in 0.5% strength by weight solution in a phenol/o-dichlorobenzene mixture in a ratio by weight of 1:1 at 25° C.) in accordance with ISO 1628.

Particular preference is given to polyesters whose carboxy end group content is up to 100 meq/kg of polyester, preferably up to 50 meq/kg of polyester and in particular up to 40 meq/kg of polyester. Polyesters of this type may be prepared, for example, by the process of DE-A 44 01 055. The carboxy end group content is usually determined by titration methods (e.g. potentiometry).

If polyester mixtures are used, the moulding compositions comprise a mixture composed of polyesters additionally including polyesters which differ from PBT, an example being polyethylene terephthalate (PET).

It is also advantageous to use recycled materials, such as PA recyclates or PET recyclates (also termed scrap PET), if appropriate mixed with polyalkylene terephthalates, such as PBT.

Recycled materials are generally:
1) those known as post-industrial recycled materials: these are production wastes during polycondensation or during processing, e.g. sprues from injection moulding, start-up material from injection moulding or extrusion, or edge trims from extruded sheets or foils.
2) post-consumer recycled materials: these are plastic items which are collected and treated after utilization by the end consumer. Blow-moulded PET bottles for mineral water, soft drinks and juices are easily the predominant items in terms of quantity.

Both types of recycled material may be used either as ground material or in the form of pellets. In the latter case, the crude recycled materials are separated and purified and then melted and pelletized using an extruder. This usually facilitates handling and free flow, and metering for further steps in processing.

The recycled materials used may be either pelletized or in the form of regrind. The edge length should not be more than 10 mm, preferably less than 8 mm.

Because polyesters undergo hydrolytic cleavage during processing (due to traces of moisture) it is advisable to predry the recycled material. The residual moisture content after drying is preferably <0.2%, in particular <0.05%.

Another group that may be mentioned of polyesters whose use is preferred is that of fully aromatic polyesters derived from aromatic dicarboxylic acids and aromatic dihydroxy compounds.

Suitable aromatic dicarboxylic acids are the compounds previously mentioned for the polyalkylene terephthalates. The mixtures preferably used are composed of from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the general formula (I)

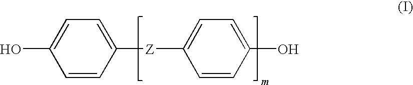

where
Z is an alkylene or cycloalkylene group having up to 8 carbon atoms, an arylene group having up to 12 carbon atoms, a carbonyl group, a sulphonyl group, an oxygen or sulphur atom, or a chemical bond, and where
m is from 0 to 2.

The phenylene groups of the compounds may also have substitution by C₁-C₆-alkyl or -alkoxy groups and fluorine, chlorine or bromine.

Examples of parent compounds for these compounds are dihydroxybiphenyl, di(hydroxyphenyl)alkane, di(hydroxyphenyl)cycloalkane, di(hydroxyphenyl) sulphide, di(hydroxyphenyl) ether, di(hydroxyphenyl) ketone, di(hydroxyphenyl) sulphoxide, a,a′-di(hydroxyphenyl)dialkylbenzene, di(hydroxyphenyl) sulphone, di(hydroxybenzoyl)benzene, resorcinol, and hydroquinone, and also the ring-alkylated and ring-halogenated derivatives of these.

Among these, preference is given to 4,4′-dihydroxybiphenyl, 2,4-di(4′-hydroxyphenyl)-2-methylbutane, a,a′-di(4-hydroxyphenyl)-p-diisopropylbenzene, 2,2-di(3′-methyl-4′-hydroxyphenyl)propane, and 2,2-di(3′-chloro-4′-hydroxyphenyl)propane, and in particular to 2,2-di(4′-hydroxyphenyl)propane, 2,2-di(3′,5-dichlorodihydroxyphenyl)propane, 1,1-di(4′-hydroxyphenyl)cyclohexane, 3,4′-dihydroxybenzophenone, 4,4′-dihydroxydiphenyl sulphone and 2,2-di(3′,5′-dimethyl-4′-hydroxyphenyl)propane and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known and are described in the literature, e.g. in U.S. Pat. No. 3,651,014.

Corresponding products are also available commercially, e.g. Hytrel® (DuPont).

According to the invention, materials whose use is preferred as polyesters also include halogen-free polycarbonates. Examples of suitable halogen-free polycarbonates are those based on diphenols of the general formula (II)

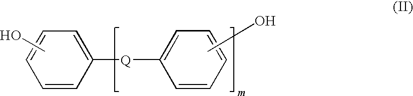

where
Q is a single bond, a C₁-C₈-alkylene, C₂-C₃-alkylidene, C₃-C₆-cycloalkylidene, C₆-C₁₂-arylene
   group, or —O—, —S— or —SO₂—, and m is a whole number from 0 to 2.

The phenylene radicals of the diphenols may also have substituents, such as C₁-C₆-alkyl or C1-C6 alkoxy.

Examples of preferred diphenols of the formula are hydroquinone, resorcinol, 4,4′-di-hydroxybiphenyl, 2,2-bis(4-hydroxyphenyl)propane, 2,4-bis(4-hydroxyphenyl)-2-methylbutane 5 and 1,1-bis(4-hydroxyphenyl)cyclohexane. Particular preference is given to 2,2-bis(4-hydroxyphenyl)propane and 1,1-bis(4-hydroxyphenyl)cyclohexane, and also to 1,1-bis(4-hydroxyphenyl)-3,3,5-trimethylcyclohexane.

Either homopolycarbonates or copolycarbonates are suitable as component A, and preference is given to the copolycarbonates of bisphenol A, as well as to bisphenol A homopolymer.

Suitable polycarbonates may be branched in a known manner, specifically and preferably by incorporating from 0.05 to 2.0 mol %, based on the total of the diphenols used, of at least trifunctional compounds, especially those having three or more phenolic OH groups.

Polycarbonates which have proven particularly suitable have relative viscosities Ti_{re′} of from 1.10 to 1.50, in particular from 1.25 to 1.40. This corresponds to an average molar mass M_{w} (weight-average) of from 10 000 to 200 000 g/mol, preferably from 20 000 to 80 000 g/mol.

The diphenols of the general formula are known or can be prepared by known processes.

The polycarbonates may, for example, be prepared by reacting the diphenols with phosgene in the interfacial process, or with phosgene in the homogeneous-phase process (known as the pyridine process), and in each case the desired molecular weight may be achieved in a known manner by using an appropriate amount of known chain terminators. (In relation to polydiorganosiloxane-containing polycarbonates see, for example, DE-A 33 34 782.)

Examples of suitable chain terminators are phenol, p-tert-butylphenol, or else long-chain alkylphenols, such as 4-(1,3-tetramethylbutyl)phenol as in DE-A 28 42 005, or monoalkylphenols, or dialkylphenols with a total of from 8 to 20 carbon atoms in the alkyl substituents as in DE-A-35 06 472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

For the purposes of the present invention, halogen-free polycarbonates are polycarbonates composed of halogen-free diphenols, of halogen-free chain terminators and, if used, halogen-free branching agents, where the content of subordinate amounts at the ppm level of hydrolyzable 30 chlorine, resulting, for example, from the preparation of the polycarbonates with phosgene in the interfacial process, is not regarded as meriting the term halogen-containing for the purposes of the invention. Polycarbonates of this type with contents of hydrolyzable chlorine at the ppm level are halogen-free polycarbonates for the purposes of the present invention.

Other suitable thermoplastic polymers that may be mentioned are amorphous polyester carbonates, where during the preparation process phosgene has been replaced by aromatic dicarboxylic acid units, such as isophthalic acid and/or terephthalic acid units. Reference may be made at this point to EP-A 0 711 810 for further details.

EP-A 365 916 describes other suitable copolycarbonates having cycloalkyl radicals as monomer units.

It is also possible for bisphenol A to be replaced by bisphenol TMC. Polycarbonates of this type are obtainable from Bayer AG with the trademark APEC HT®.

In another preferred embodiment of the present invention, the polymer moulding compositions comprise from 0.001 to 75 parts by weight, preferably from 10 to 70 parts by weight, particularly preferably from 20 to 65 parts by weight, with particular preference from 30 to 65 parts by weight, of a filler or reinforcing material.

The filler or reinforcing material used can also comprise a mixture composed of two or more different fillers and/or reinforcing materials, for example based on talc, or mica, silicate, quartz, titanium dioxide, wollastonite, kaolin, amorphous silicas, magnesium carbonate, chalk, feldspar, barium sulphate, glass beads and/or fibrous fillers and/or reinforcing materials based on carbon fibres and/or glass fibres. It is preferable to use mineral particulate fillers based on talc, mica, silicate, quartz, titanium dioxide, wollastonite, kaolin, amorphous silicas, magnesium carbonate, chalk, feldspar, barium sulphate and/or glass fibres. It is particularly preferable to use mineral particulate fillers based on talc, wollastonite, kaolin and/or glass fibres, very particular preference being given to glass fibres.

Particular preference is moreover also given to the use of acicular mineral fillers. According to the invention, the term acicular mineral fillers means a mineral filler having pronounced acicular character. An example that may be mentioned is acicular wollastonites. The length: diameter ratio of the mineral is preferably from 2:1 to 35:1, particularly preferably from 3:1 to 19:1, with particular preference from 4:1 to 12:1. The average particle size, determined using a CILAS GRANULOMETER, of the inventive acicular minerals is preferably smaller than 20 um, particularly preferably smaller than 15 um, with particular preference smaller than 10 um.

The filler and/or reinforcing material can, if appropriate, have been surface-modified, for example with a coupling agent or coupling-agent system, for example based on silane. However, this pre-treatment is not essential. However, in particular when glass fibres are used it is also possible to use polymer dispersions, film-formers, branching agents and/or glass-fibre-processing aids, in addition to silanes.

The glass fibres whose use is particularly preferred according to the invention are added in the form of continuous-filament fibres or in the form of chopped or ground glass fibres, their fibre diameter generally being from 7 to 18 um, preferably from 9 to 15 um. The fibres can have been provided with a suitable size system and with a coupling agent or coupling-agent system, for example based on silane.

Coupling agents based on silane and commonly used for the pre-treatment are silane compounds, preferably silane compounds of the general formula (III)

(X—(CH₂)_{q})ₖ—Si-(0-CᵣH₂₊₁)₄₋ₖ (III)

in which

X is NH₂—, HO— or

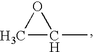

q is a whole number from 2 to 10, preferably from 3 to 4,

r is a whole number from 1 to 5, preferably from 1 to 2 and

k is a whole number from 1 to 3, preferably 1.

Coupling agents to which further preference is given are silane compounds from the group of aminopropyltrimethoxysilane, aminobutyltrimethoxysilane, aminopropyltriethoxysilane, aminobutyltriethoxysilane, and also the corresponding silanes which have a glycidyl group as substituent X.

The amounts generally used of the silane compounds for surface coating for modification of the fillers is from 0.05 to 2% by weight, preferably from 0.25 to 1.5% by weight and in particular from 0.5 to 1% by weight, based on the mineral filler.

The d97 or d50 value of the particulate fillers can, as a result of the processing to give the moulding composition or the moulding, be smaller in the moulding composition or in the moulding than in the fillers originally used. The length distributions of the glass fibres can, as a result of the processing to give the moulding composition or to give the moulding, be shorter in the moulding composition or in the moulding.

For clarification, it should be noted that the scope of the invention comprises any desired combinations of all of the definitions and parameters listed above in general terms or in preferred ranges.

### BRIEF DESCRIPTION OF THE SEVERAL VIEWS OF THE DRAWINGS

The invention is described purely by way of example below, using the attached figures:

FIG. 1 shows a section of a transverse-member module according to the invention partially overmoulded with plastic which extends over the structure 3 entirely composed of plastic in a ribbed design as far as the sheet-metal profile 2, which it likewise partially surrounds. The structure of the sheet-metal profile 2 overmoulded with plastic has securing points 4 for the steering column and securing points 5 for the front wall of the vehicle bodywork.

FIG. 2 shows another view of the transverse-member module of the invention, composed of steering-column retainer and metal tube.

FIG. 3 illustrates the sheet-metal profile of the steering-column retainer without plastics structure.

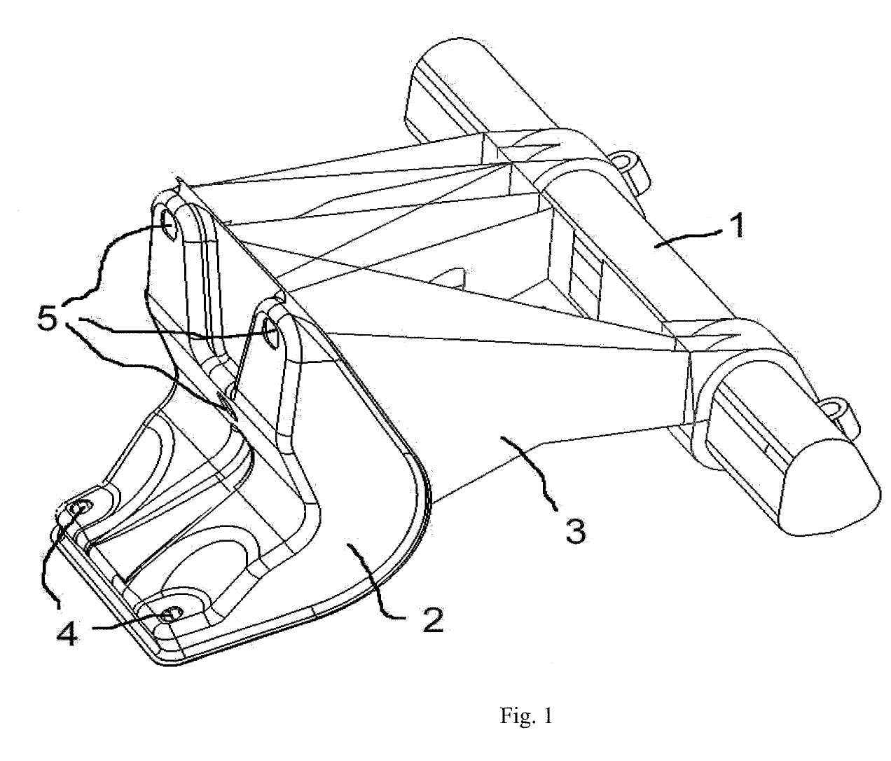

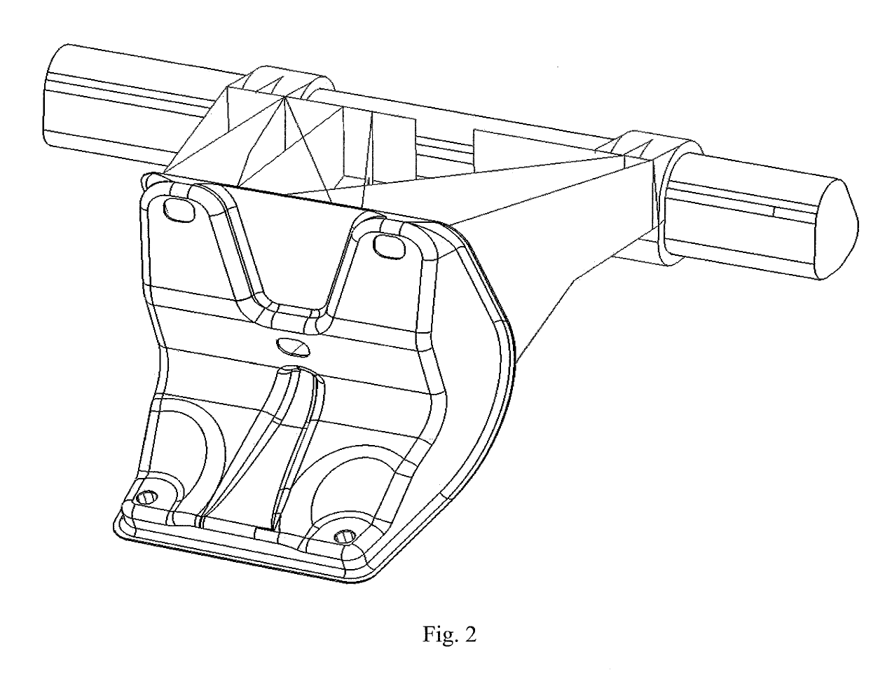

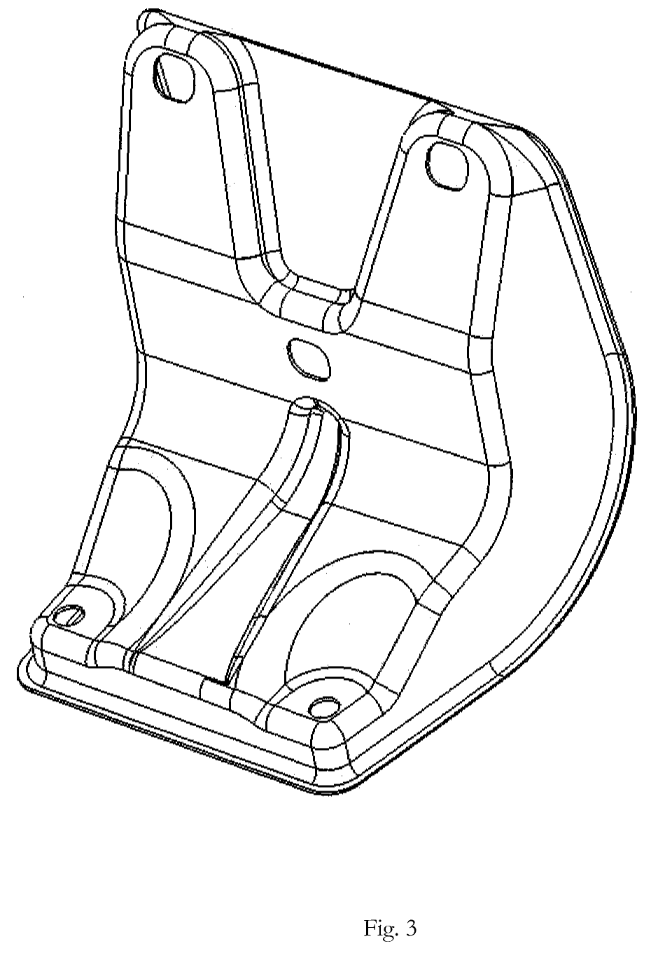

The perforations in the sheet-metal profile are not shown (FIG. 3), and nor are the areas of plastic moulded over and through these and moulded over the edges (FIGS. 1 and 2).

### METHODS FOR CARRYING OUT THE INVENTION

The metal tube generally indicated by reference numeral 1 in the transverse-member module is shown only partially in FIG. 1, and without any specific shaping of the metal tube or of any individual link elements. However, it should be clear that the specific geometry is intended only as an example, to the extent that this is not apparent from the explanation below.

The section shown from a transverse-member module of the invention, composed of steering-column retainer and metal tube, serves to receive the instrument panel of a vehicle, and is linked to the A-pillars (not shown) of a motor vehicle during assembly. The transverse-member module comprises a metal tube which is seamless or which has a longitudinal weld seam, preferably a steel tube, the external dimensions of which have narrow tolerances. The metal tube has preferably been pinched at both of its ends. There are holes located at these pinched ends and serving as screw-on lugs for the A-pillars. The location of the holes is therefore in that region of the metal tube which is used by the transverse member to produce a rigid connection between the A-pillars. In order in particular also to permit absorption of large forces arising in the event of a side impact, the design of the metal tube is moreover preferably straight, i.e. the metal tube has no curved sections where bending deformation can occur when pressure forces are introduced into the metal tube by way of the pinched ends.

During the production of the transverse member, the metal tube is overmoulded with plastic in an injection-moulding plant. It is preferable here to use fibre-reinforced plastic, e.g. glass-fibre-filled plastic. The material PA GF30 (polyamide with 30% by weight glass fibre content) has proven particularly suitable here. The overmoulded plastic can cover the entire metal tube, or else there can be regions where it has no overmoulded plastic. If the metal tube is not to be completely overmoulded, there are particular requirements placed upon the dimensional accuracy of the moulds, and also of the metal tube, in the injection-moulding plant, and the metal tube should therefore have narrow tolerances with respect to the external dimensions.

The advantage of using plastic to overmould the metal tube is that sites where high strength and stiffness is demanded can be realized via the metal tube whereas sites serving merely for linking of components described in more detail below can be moulded on, from plastic. In the same way it is also possible to achieve further differentiation within the plastic used. By way of example, it would be possible to use a fibre-reinforced and in particular glass-fibre-filled plastic only at those sites where in turn increased mechanical requirements are placed upon the plastic, whereas conventional plastic without fibre reinforcement can be used in other regions. In the case of the transverse member-module part shown in FIG. 1, the only section shown is the section securely connected to the steering-column retainer. All of the plastics parts here can be moulded on in a single manufacturing step.

DE 10 2005 004 605 A1 discloses alternative embodiments, and also further elements, and also 20 production methods for the metal tube of the transverse member.

In contrast to solutions consisting entirely of plastic, the plastics-metal-composite solution described in the present invention for the transverse-member module in the than of metal tube and steering-column retainer permits achievement of first-mode natural frequencies >36 Hz in the installed condition, these otherwise being achievable only by using designs which are composed of metal and are therefore markedly heavier.

The structure of the transverse-member module composed of metal tube and steering-column retainer, both using hybrid technology, preferably with plastics ribbing, is designed so as also to guarantee a simple, robust production process.

1-10. (canceled)

11. A transverse-member module for receiving an instrument panel of a motor vehicle comprising
at least a partially plastic-surrounded metal tube,
a molded sheet-metal profile functioning as a steering column retainer, designed and placed in such a way that the molded sheet-metal profile, in composite with molded-on plastic, provides a stiff connection between a steering column and a front wall and provides a connection to the metal tube by way of a plastic structure.

12. The transverse-member module according to claim 11, wherein the plastic structure has reinforcing ribs.

13. The transverse-member module according to claim 12, wherein the reinforcing ribs are securely connected to the sheet-metal profile at discrete connection sites of their perforations in the sheet-metal profile, and wherein the plastic extends through perforations and extends over a surfaces of the perforations.

14. The transverse-member module according to claim 11, wherein the plastic is a thermoplastic polymer.

15. The transverse-member module according to claim 14, wherein a thermoplastic polymer one of the group of polyamides, vinylaromatic polymers, polyesters, ASA polymers, ABS polymers, SAN polymers, POM, PPE, polyarylene ether sulphones, polypropylene or blends thereof.

16. The transverse-member module according to claim 14, wherein the thermoplastic polymer comprises from 0.001 to 75 parts by weight of filler or reinforcing material.

17. The transverse-member module according to claim 11, wherein the sheet-metal profile has been coated with adhesion promoter or adhesive.

18. The transverse-member module according to claim 11, wherein the metal tube has been coated with adhesion promoter or adhesive.

19. The transverse-member module according to claim 11, wherein the sheet-metal profile is connected to the plastics structure via one of hot riveting, clinching, adhesive bonding, or screw-thread methods.

20. A method for influencing an intrinsic vibration of an instrument-panel support to provide a first-mode natural frequency >36 Hz by attaching a transverse-member module under an instrument panel of a motor vehicle, comprising the steps of
providing an at least partially plastic-surrounded metal tube;
providing a molded sheet-metal profile functioning as steering-column retainer including a composite with molded-on plastic, providing a stiff connection between steering column and front wall and providing a firm connection to the metal tube by way of a structure consisting entirely of plastic.
